(19) United States
(12) Patent Application Publication
(10) Pub. No.: US 2024/0183182 A1
(43) Pub. Date: Jun. 6, 2024

(54) TILTING WATERFALL

(71) Applicant: Sundance Spas, Inc., Chino, CA (US)

(72) Inventors: Carl Arsin, La Crescenta, CA (US); Mark Knight, Venice, CA (US)

(21) Appl. No.: 18/523,617

(22) Filed: Nov. 29, 2023

Related U.S. Application Data
(60) Provisional application No. 63/429,913, filed on Dec. 2, 2022.

(51) Int. Cl. E04H 4/14; B05B 1/16; B05B 17/08

(52) U.S. Cl. CPC E04H 4/14; B05B 1/1636; B05B 17/085

(57) ABSTRACT

A tilting waterfall has a tilting body rotatable along an axis between a first position and a second position. The waterfall has a first outlet and a second outlet positioned on the tilting body. The first outlet configured to output water in a first pattern and the second outlet configured to output water in a second pattern different from the first pattern. The waterfall has a valve comprising a first opening and a second opening. The waterfall has a flow distributor comprising a first opening and a second opening. In the first position, the first opening of the valve and the first opening of the flow distributor are aligned thereby allowing flow of the water through the first outlet. In the second position, the second opening of the valve and the second opening of the flow distributor are aligned thereby allowing flow of the water through the second outlet.

### CROSS-REFERENCE TO RELATED APPLICATIONS

This application claims the benefit of U.S. Provisional Application No. 63/429,913, entitled “TILTING WATERFALL” and filed on Dec. 2, 2022, which is hereby incorporated by reference herein in its entirety.

### TECHNICAL FIELD

The present disclosure relates generally to a tilting waterfall for a spa, hot tub, swim spa, bath, showerheads, and/or pool.

### BACKGROUND

Waterfalls can improve the look of a spa, hot tub, swim spa, bath, and/or pool. Further, the sound and water spray produced by a waterfall can provide a relaxing experience. Moreover, a waterfall can improve water circulation and/or assist with water cooling. However, conventional waterfalls may provide a single spraying pattern and/or require users to step out of the spa, hot tub, swim spa, bath, and/or pool to control operation of the waterfall.

### SUMMARY

The tilting waterfalls described herein can include a tilting body in fluid connections with a source of water. In some cases, the tilting body can be adjusted between at least two positions. In a first position, the tilting body can output water via a first outlet. In a second position, the tilting body can output water via a second outlet. The tilting waterfall can be used with a spa, hot tub, swim spa, bath, and/or pool. The position of the tilting body can be manually adjusted and without the need to egress the spa, hot tub, swim spa, bath, and/or pool.

Disclosed herein is a tilting waterfall system including a tilting body. The tilting body can be configured to be in fluid connection with a source of water. In some cases, the tilting body can be rotatable along an axis between at least two positions with each position corresponding to a different water output. The tilting waterfall can include an outlet for each of the positions. For example, the tilting waterfall can include a first position and a second position with a corresponding first outlet and/or a second outlet positioned on the tilting body. The first outlet can be configured to output water in a first pattern and the second outlet can be configured to output water in a second pattern. In some cases, the second pattern can be different than the first pattern. The tilting waterfall can also include a valve and/or a flow distributor. The valve and the flow distributor can work together to direct a flow of water through at least one of the first outlet and the second outlet. In some cases, the valve and the flow distributor can restrict the flow of water through the first outlet and the second outlet. For example, the valve can direct flow toward a particular flow path defined by the flow distributor. The valve can include a first opening and a second opening. The flow distributor can include a first opening and a second opening. When the tilting body is in first position, the first opening of the valve and the first opening of the flow distributor can be aligned thereby allowing flow of the water through the first outlet. When the tilting body is in the second position, the second opening of the valve and the second opening of the flow distributor can be aligned thereby allowing flow of the water through the second outlet.

In some cases, the first outlet includes a slit, and the second outlet includes a plurality of holes. In the first position, the tilting body can be configured to be arranged at an angle between 0° and 45° relative to a top surface of a spa unit. In some cases, however, the tilting body can be configured to be arranged at an angle between 0° and 15°, 0° and 30°, and/or 0° and 60° relative to the top surface of the spa unit when the tilting body is in the first position. In the second position, the tilting body can be configured to be arranged at an angle between 45° and 90° relative to the top surface of the spa unit. In some cases, however, the tilting body can be configured to be arranged at an angle between 45° and 75°, 45° and 60°, and/or 30° and 105° relative to the top surface of the spa unit.

The tilting body can be rotatable to a third position in which the first opening and the second opening of the valve are not aligned with either of the first opening and the second opening of the flow distributor thereby restricting the flow of water through the first outlet and the second outlet. In some cases, the tilting body can include a first chamber and a second chamber. The first chamber can be in fluid communication with the first opening of the valve and the first outlet. The second chamber can be in fluid communication with the second opening of the valve and the second outlet. The tilting body can include a plate positioned between the first and second chambers and configured to seal the first and second chambers from each other. In some cases, the second outlet of the tilting waterfall can be arranged in a parallel to the first outlet. The tilting body can include a face having the first outlet and the second outlet. In some cases, the valve can be positioned within the tilting body. The valve can be positioned on an opposite side of the tilting body from the first outlet and the second outlet, and the flow distributor can be positioned between the valve and the first and second outlets.

In some variants, a waterfall system for a spa unit can include a housing. The housing can include a first outlet and a second outlet. In some cases, the housing can be adjustable between at least a first position and a second position. The waterfall system can include a flow restrictor (e.g., a valve) positioned inside the housing. The flow restrictor can block a first flow path toward the first outlet when the housing is in the second position. The flow restrictor can block a second flow path toward the second outlet when the housing is in the first position.

The waterfall system of any of the preceding paragraphs can include a flow distributor including a first opening and a second opening. In some cases, the flow restrictor can include a first opening and a second opening. The first opening of the flow restrictor and the first opening of the flow distributor can be at least partially aligned when the housing is in the first position. The second opening of the flow restrictor and the second opening of the flow distributor can be at least partially aligned when the housing is in the second position.

The housing can be in fluid communication with a source of water. In some cases, the first outlet can be configured to spray water in a first pattern, and the second outlet can be configured to spray water in a second pattern different than the first pattern. The flow restrictor can include a slit. The housing can include a plate between the first flow path and the second flow path. The slit can be configured to receive and secure the plate. In the first position, the housing can be configured to be arranged at an angle between 0° and 45° relative to a top surface of the spa unit. In some cases, however, the housing can be configured to be arranged at an angle between 0° and 15°, 0° and 30°, and/or 0° and 60° relative to the top surface of the spa unit when the housing is in the first position. In the second position, the housing can be configured to be arranged at an angle between 45° and 90° relative to a top surface of the spa unit. In some cases, however, the housing can be configured to be arranged at an angle between 45° and 75°, 45° and 60°, and/or 30° and 105° relative to the top surface of the spa unit when the housing is in the second position.

In some cases, the waterfall system can include a flow distributor. The flow distributor can include least one stopper. The flow restrictor can include at least one tab. The at least one stopper can be configured to restrict movement of the stopper so that the housing is not movable beyond a position where the housing is arranged at a first angle relative to a top surface of the spa unit. The first angle can include an angle of 0°. In some cases, however, the first angle can include an angle of 90°. In some variants, the first outlet can include a slit, and the second outlet can include a plurality of holes.

The housing can be adjustable to a third position wherein the flow restrictor blocks the first flow path and the second flow path. In some cases, the first outlet can be arranged in a parallel to the second outlet.

### BRIEF DESCRIPTION OF THE DRAWINGS

FIG. 1 shows a tilting waterfall system attached to a spa unit.

FIG. 2A shows the tilting waterfall system shown in FIG. 1.

FIG. 2B shows a cross-section view of the tilting waterfall system shown in FIG. 2A.

FIG. 2C shows an exploded view of a tilting panel of the tilting waterfall system shown in FIG. 2A.

FIG. 2D shows a tilting panel with inlets.

FIG. 2E shows two inlets attached to a flow distributor.

FIG. 2F shows a valve partially disposed inside a tilting panel.

FIG. 3A shows the tilting waterfall system shown in FIG. 1 with a tilting panel in the first position.

FIG. 3B shows a cross-section view of the tilting waterfall system shown in FIG. 3A with the tilting panel in the first position.

FIG. 4A shows the tilting waterfall system shown in FIG. 1 with the tilting panel in the second position.

FIG. 4B shows a cross-section view of the tilting waterfall system shown in FIG. 4A with the tilting panel in the second position.

FIG. 5A shows the tilting waterfall system shown in FIG. 1 with the tilting panel in the third position.

FIG. 5B shows a cross-section view of the tilting waterfall system shown in FIG. 5A with the tilting panel in the third position.

### DETAILED DESCRIPTION

Tilting waterfalls for a body of water, such as a spa, hot tub, swim spa, bath, showerheads, and/or pool and components thereof, are described herein. A tilting waterfall can include a tilting body which can be adjusted between a plurality of positions. For example, the tilting body can be adjusted to a first position where the tilting waterfall sprays water in a first pattern. The tilting body can be adjusted to a second position different than the first position. When the tilting body is in the second position, the tilting waterfall can spray water in a second pattern different than the first pattern. In some cases, the tilting body can be adjusted to a third position. The flow of water through the tilting waterfall can be stopped by positioning tilting body in the third position. The tilting body can easily be adjusted between the plurality by positions by manually tilting the tilting body. This can beneficially allow users to easily adjust the position of the tilting body to change the spray pattern of the tilting waterfall and/or shut off the flow of water through tilting waterfall.

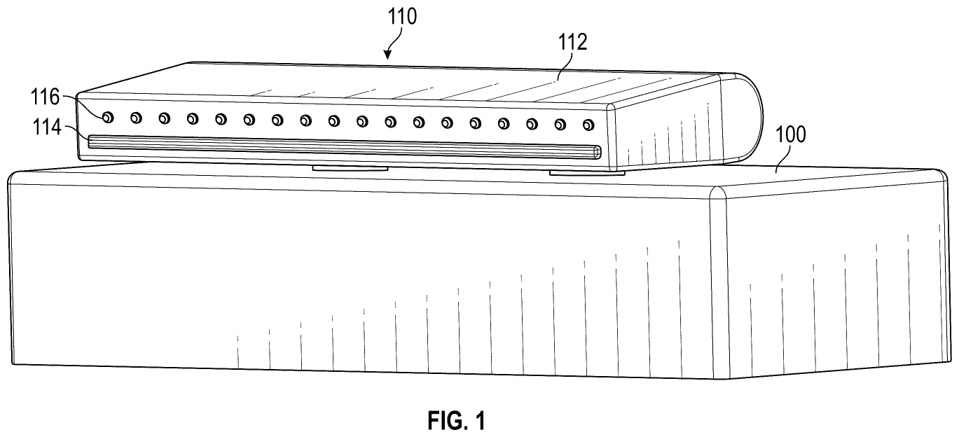

FIG. 1 shows a tilting waterfall system 110. The tilting waterfall system 110 can be used in any water environment, for example, with a spa, hot tub, swim spa, bath, showerheads, and/or pool. Although the examples described below are described in connection with a spa unit, the tilting waterfall can be used in any water environment.

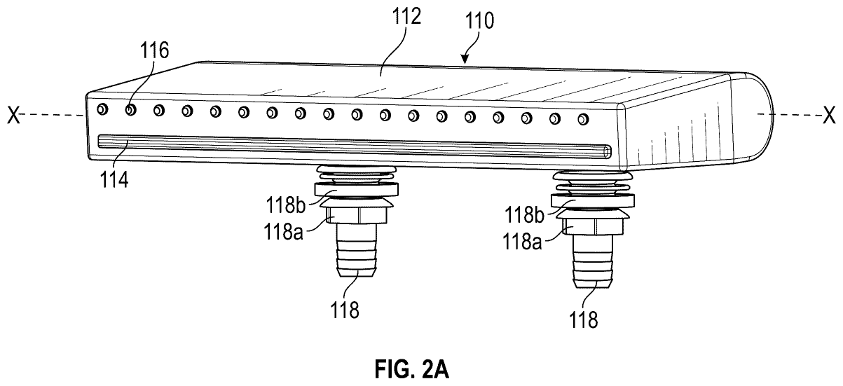

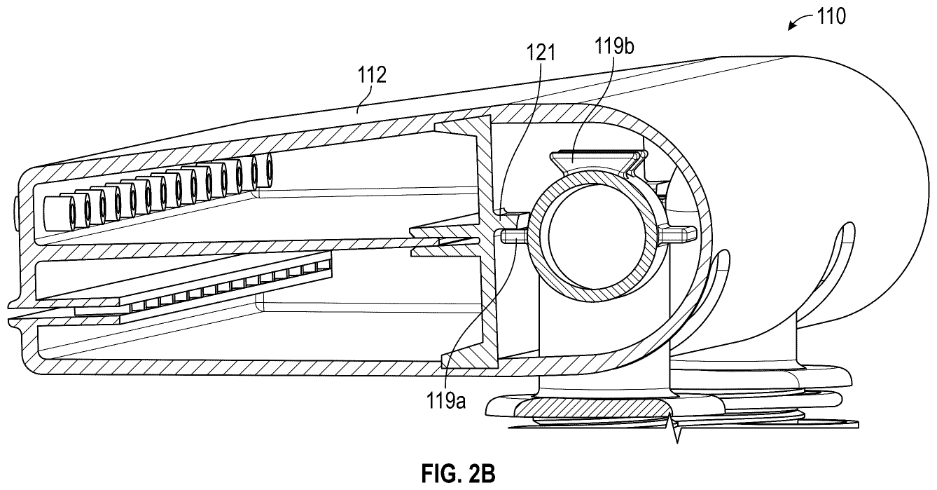

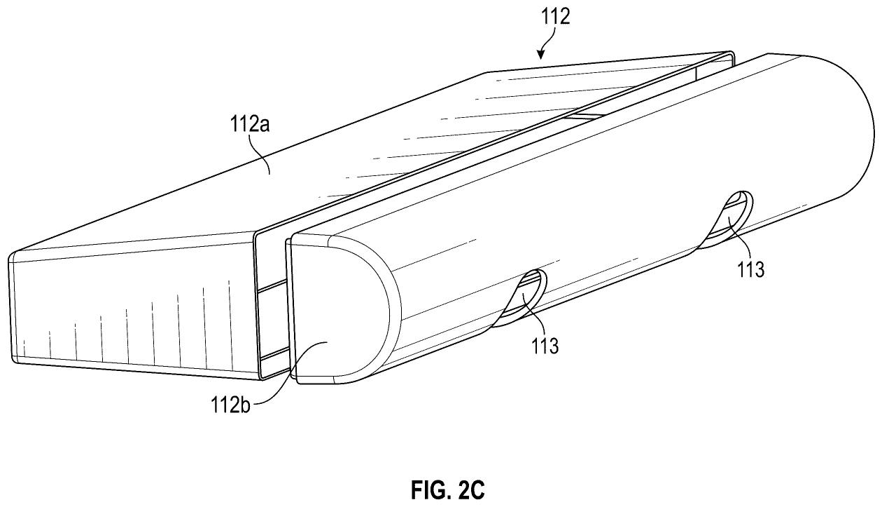

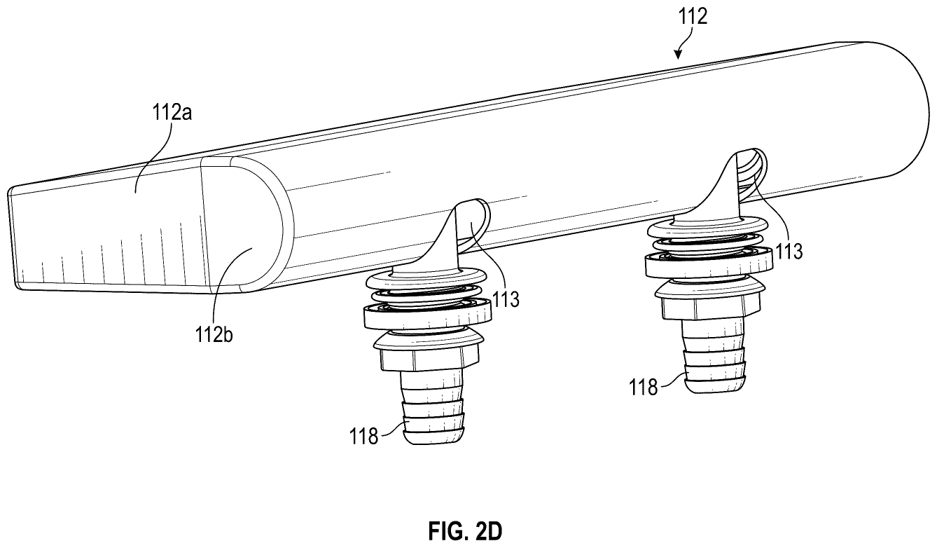

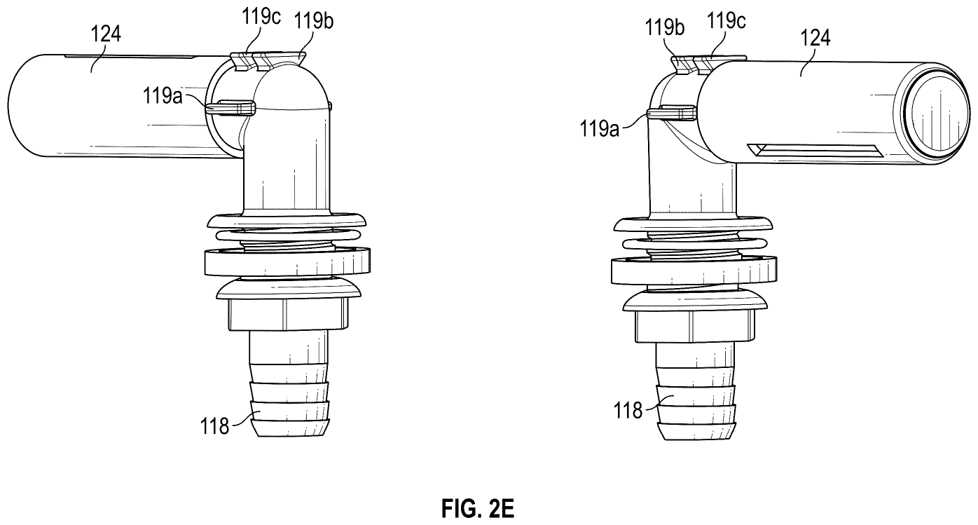

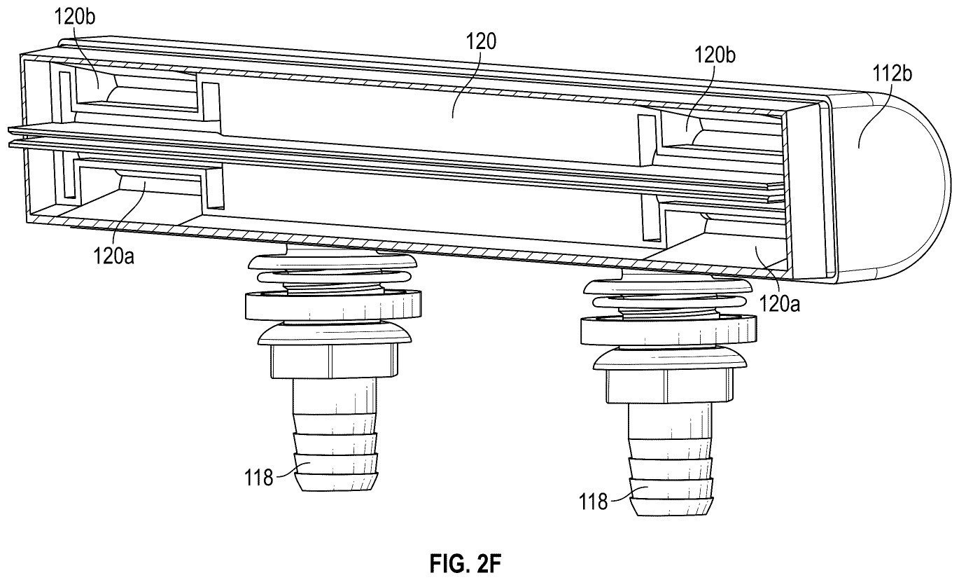

As shown in FIG. 1, the tilting waterfall system 110 can be mounted to, for example, the edge of a spa unit 100. The tilting waterfall system 110 can include a tilting panel 112, also referred herein to as a tilting body or a tilting housing, and one or more outlets, for example a first outlet 114, and a second outlet 116. As illustrated the tilting panel 112 includes both the first outlet 114 and the second outlet 116. The first outlet 114 and the second outlet 116 are arranged on the same face of the tilting panel 112. As illustrated, each of the first outlet 114 and the second outlet 116 are arranged in a generally elongate pattern and arranged parallel to each other, but other configurations are possible. The tilting waterfall system 110 can also include one or more inlets 118, as shown in FIG. 2A.

The inlets 118 can be in fluid connection with the tilting panel 112 and a source of water, for example the plumbing system of the spa unit 100. Each inlet 118 can include a nut 118a and a washer 118b. The nut 118a and the washer 118b can beneficially facilitate attachment of the inlets 118 to the tilting panel 112 and prevent water leaks. Water can enter the tilting panel 112 via the inlets 118 and exit the tilting panel 112 via the first outlet 114 and/or the second outlet 116. Although reference is made to the tilting waterfall system 110 including two inlets 118 and two outlets 114, 116, the tilting waterfall can include a single inlet or more than two inlets, and a single outlet or more than two outlets. In some cases, the tilting waterfall system 110 can include lighting (not shown). For example, one or more LEDs can be positioned on an exterior surface of the tilting panel 112 and/or adjacent to the outlets 114, 116. The lighting pattern may change with the position of the tilting panel 112.

The first and second outlets 114, 116 can include different shapes and/or patterns which can beneficially allow the tilting waterfall system 110 to create various spray patterns. For example, the first outlet 114 can include one or more elongate slits which can, when water flows through it, produce a spray pattern similar to that of a waterfall. The second outlet 116 can include a plurality of holes (e.g., circular holes) which can, when water flows through them, create a spray effect similar to that of a fountain or shower. Although the second outlet 116 is shown as having eighteen holes, the second outlet 116 can include more than or less than eighteen holes. The number of holes in the second outlet 116 can alter the pressure of the water as the water flows though the holes. For example, including less than eighteen holes on the second outlet can cause the pressure of the water flowing through the holes to increase as less holes are available for the water to exit the tilting waterfall system 110. Including more than eighteen holes, on the other hand, can cause the pressure of the water flowing through the holes to decrease as more holes are available for the water to exit the tilting waterfall system 110. The increased or decreased pressure can cause the water exiting the tilting waterfall system 110 via the second outlet 116 to reach different distances. In some cases, the holes of the second outlet 116 can dispense water in a sequence. For example, a subset of the holes of the second outlet 116 can start spraying water before a second subset of holes. The subset of holes spaying water can, in some cases, change as the tilting panel 112 moves. In some configurations, the first and second outlets 114, 116 can output similar spray patterns but at different angles depending on the position of the tilting panel 112.

Although not shown, the tilting waterfall system 110 can include more than two types of outlets which can beneficially allow users to select from various spraying patterns. For example, the tilting waterfall system 110 could include additional outlets with varying numbers of holes and/or slit dimensions to create the different pressure effects described above.

Users can switch between spraying patterns, and/or restrict the flow of water, by manually adjusting (e.g., pivoting) the position of the tilting panel 112. Adjusting the position of the tilting panel 112 can cause flow of water inside the tilting panel 112 to change. For instance, the tilting panel 112 can be rotated along an axis X, as shown in FIG. 2A, to change the position of the tilting panel 112 between at least two positions. In other configurations, the tilting panel 112 may be designed to rotate about a different axis, for example an axis perpendicular to axis X. The tilting panel 112 can be transitioned from one position to another by tilting the tilting panel 112 up or down. When the tilting panel 112 is moved, the entire tilting panel 112 and the outlets 114, 116 move thereby ensuring that the position of the outlets 114, 116 relative to each other stays constant not withstanding movement of the panel 112. Although the tilting panel 112 can be manually tilted by directly manipulating the tilting panel 112, it is possible that the system includes an actuator (e.g., button, lever, dial, knob, etc.) to manually or electronically manipulate the tilting panel. The actuator can be disposed on the tilting waterfall system 110 or the spa unit 100. In some cases, the tilting waterfall system 110 can include one or more stoppers 119a, 119b, 119c as shown in FIG. 2E, which can restrict movement of the tilting panel 112 by restricting movement of a valve tab 121, as shown in FIG. 2B. The stoppers 119a, 119b, 119c can extend outwardly from the body of the inlet 118, but could be on other components like flow distributor 124. In other embodiments, tilting panel 112 may be remotely controlled by a mobile application on a user device. The tilting panel 112 may be automatically initiated upon activation of another spa component, for example jets or lights, or removing a cover from the spa.

As shown in FIG. 2C, the tilting panel can include a front portion 112a and a back portion 112b. The back portion 112b can include one or more openings 113 which the inlets 118 can extend through, as shown in FIG. 2D. The tilting waterfall system 110 can include one or more flow distributors. For example, each inlet 118 can be in fluid connection with a corresponding flow distributor 124, as shown in FIG. 2E, to permit flow of water from the inlet 118 to the flow distributor 124 and, as further discussed below, into the first and second chambers 134, 136. As illustrated, the flow distributor 124 extends at an angle relative to the corresponding inlet 118, for example perpendicularly. The illustrated tilting waterfall system 110 includes two flow distributors 124, but fewer or additional flow distributors may be present.

FIG. 2F shows a valve 120, also referred herein to as a flow restrictor, at least partially disposed inside the back portion 112b of the tilting panel 112. As illustrated, the tilting waterfall system 110 includes a single valve structure facilitating flow from multiple inlets 118 to the tilting panel 112, but it is also possible the tilting waterfall system 110 includes one or more valve structures for each inlet 118. The valve 120 can include at least one or more openings 120a, 120b which can beneficially direct the flow of water from the flow distributor 124 to the first and second chambers 134, 136 and the first and second outlets 114, 116. For example, the valve 120 can include one or more first openings 120a and one or more second openings 120b for directing flow into respective chambers 134, 136 of the tilting panel 112. As illustrated, the valve includes a first pair of openings 120a, 120b corresponding to a first inlet or first flow distributor and a second pair of openings 120a, 120b corresponding to a second inlet or second flow distributor. The first and second pairs of openings may be separated by a wall such that each pair of openings corresponds to a particular inlet.

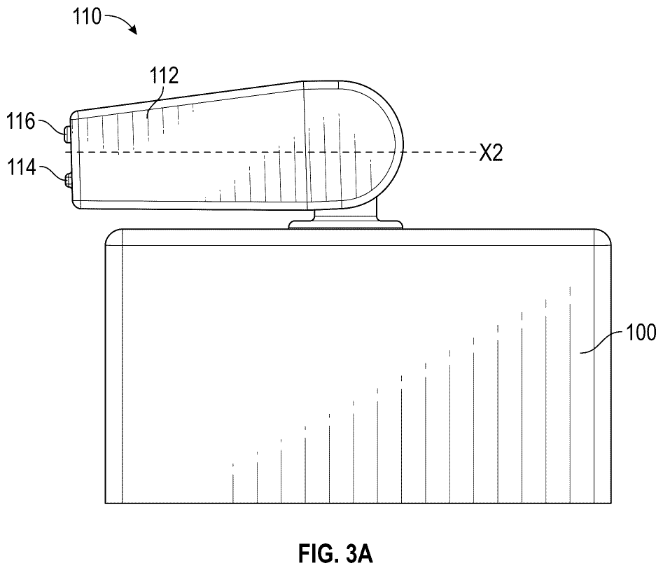

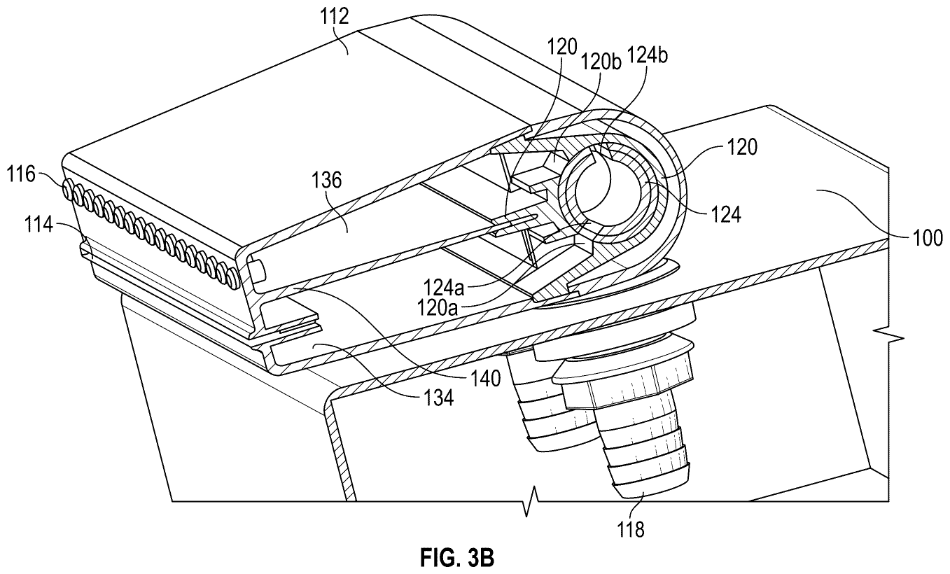

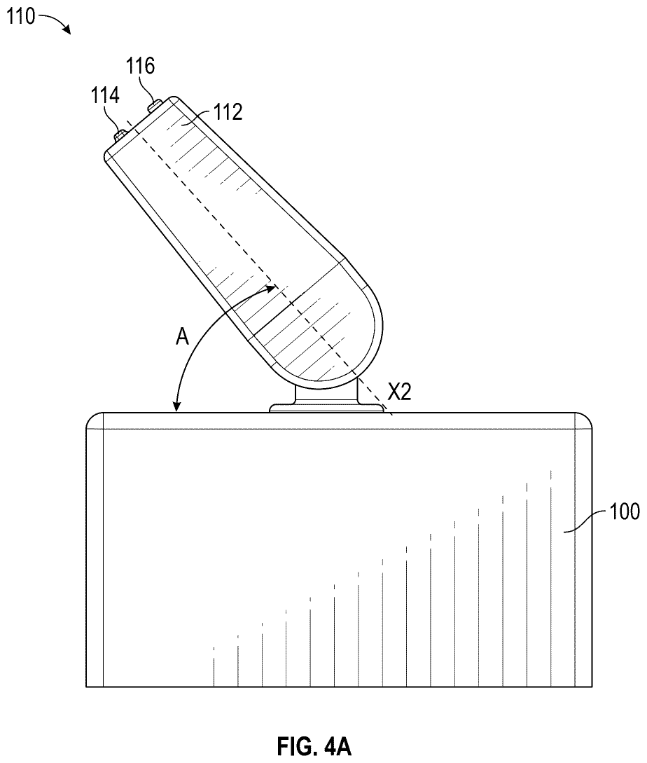

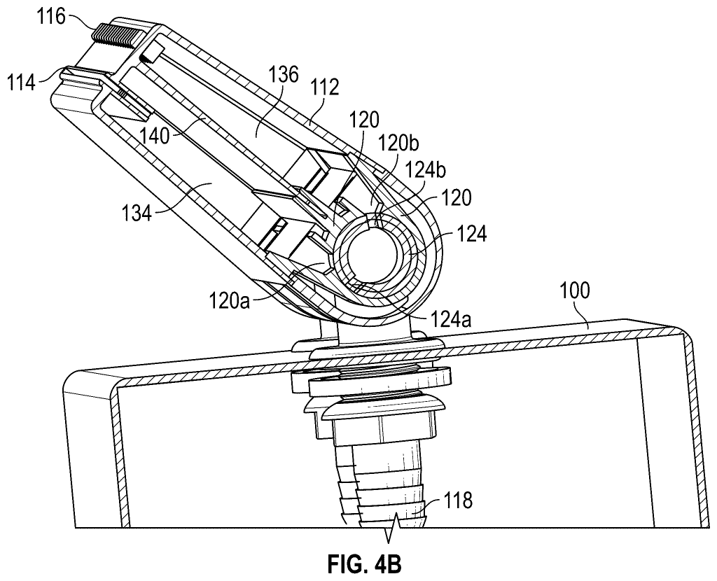

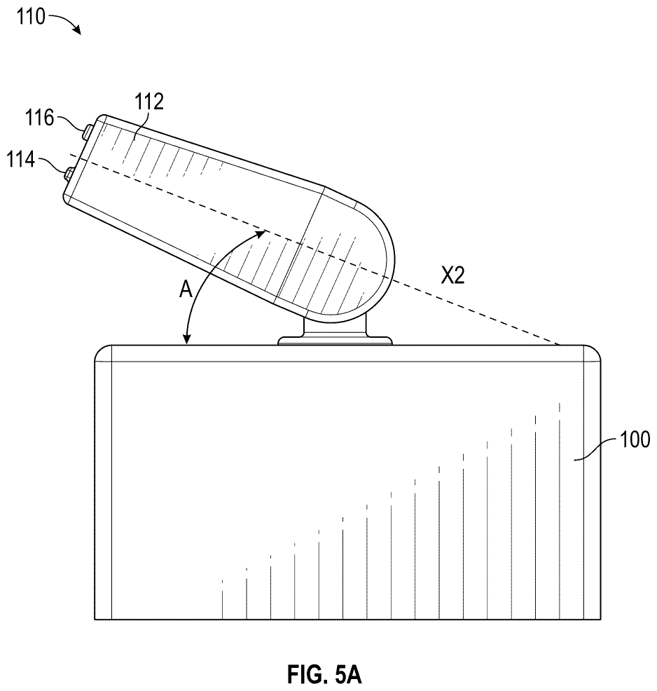

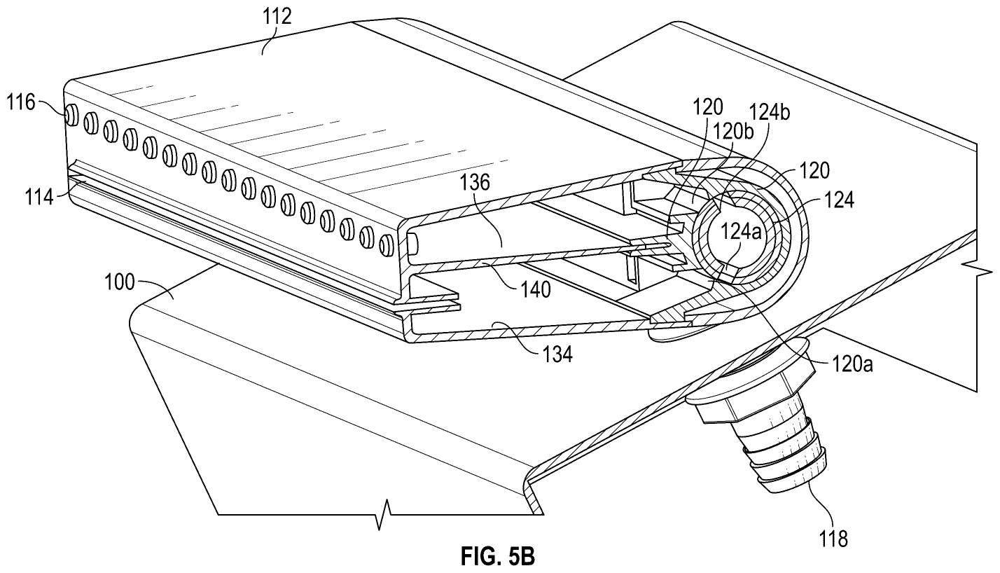

In a first position, as shown in FIGS. 3A-3B, the tilting panel 112 can cause the water to flow through the first outlet 114 thereby creating a waterfall spraying pattern. In some cases, the first position can include any position in which a central axis X2 of the tilting panel 112 and a top surface of the spa unit 100 (or ground) are parallel or substantially parallel to each other. In other cases, the first position can include any position in which the tilting panel 112 and a top surface of the spa unit 100 form an angle A between about 0° and about 45o and/or between about 0° to about 30°. In a second position, as shown in FIGS. 4A-4B, the tilting panel 112 can cause the water to flow through the second outlet 116 thereby creating a fountain or shower spraying pattern. In some cases, the second position can include any position in which the central axis X2 of the tilting panel 112 and a top surface of the spa unit 100 form an angle A between about 45° and about 90° and/or between about 60° and about 90°. In a third position, as shown in FIGS. 5A-5B, the tilting panel 112 can also cause the tilting waterfall system 110 to shut off the flow of water through the outlets 114, 116. In some cases, the third position can include any position in which the central axis X2 of the tilting panel 112 and a top surface of the spa unit 100 form an angle A between about 30° and about 60°, for example 45°.

The tilting waterfall system 110 can also include a valve 120 and a flow distributor 124 disposed inside the tilting panel 112, as shown in FIGS. 3B, 4B, and 5B. The valve 120 can include one or more openings 120a, 120b corresponding to the number of outlets. As shown in FIG. 2F, each of the one or more openings 120a, 120b can create an elongate or rectangular passageway. The one or more openings 120a, 120b can align with an opening (e.g., opening 124a, 124b) of the flow distributor 124 depending on the position of the tilting panel 112. The flow distributor 124 can have an outer wall defining a lumen, for example a generally circular lumen. The flow distributor 124 can include one or more openings 124a, 124b extending through the outer wall permitting water to flow from the inlets 118 to an interior of the tilting panel 112. As shown in FIG. 2E, the one or more openings 124a, 124b can be elongate rectangular openings. The flow distributor 124 can lack partitions or channels within the lumen of the flow distributor 124 separating water flow between the one or more openings 124a, 124b.

Moving the tilting panel 112 from one position to another can cause the valve 120 to change the flow of water from one outlet to another. For example, when the tilting panel 112 is in a first position, the valve 120 can block a flow path between the first outlet 114 and the inlets 118. When the tilting panel 112 is in a second position different than the first position, the valve 120 can block flow path between the second outlet 116 and the inlets 118. As illustrated in FIGS. 3B, 4B, and 5B, moving the tilting panel 112, causes the valve 120 to rotate with the tilting panel 112 and/or relative to the flow distributor 124. For example, when the tilting panel 112 is in the first position (FIG. 3B), a flow path between the valve 120 can allow flow of water through a first chamber 134, which is in fluid communication with the first outlet 114 but restrict flow of water through a second chamber 136, which is in fluid communication with the second outlet 116. In the first position, a first opening 120a of the valve 120 and a first opening 124a of the flow distributor 124 can align thereby allowing the flow of water through the first chamber 134. The flow of water through the second chamber 136 will be restricted as the second opening 120b of the valve 120 and the second opening 124b of the flow distributor 124 are not aligned. A plate 140 can insulate the first and second chambers 134, 136 (e.g., seal them from each other). Flow of water through the first chamber 134 and the first outlet 114, as previously mentioned, can result in a first spraying effect (e.g., a waterfall spraying effect).

When the tilting panel 112 is in the second position (FIG. 5B), the valve 120 can allow flow of water through the second chamber 136, which is in fluid communication with the second outlet 116 but restrict flow of water through the first chamber 134, which is in fluid communication with the first outlet 114. In the second position, the second opening 120b of the valve 120 and the second opening 124b of the flow distributor 124 can align thereby allowing the flow of water through the second chamber 136. Flow of water through the second chamber 136 and the second outlet 116 can result in a second spraying effect (e.g., a fountain or shower spraying effect). The flow of water through the first chamber 134 will be restricted as the first opening 120a of the valve 120 and the first opening 124b of the flow distributor 124 are not aligned.

When the tilting panel 112 is in the third position, as shown in FIGS. 4A-4B, the valve 120 can restrict the flow of water through the first and second chambers 134, 136, thereby shutting off the flow of water. The valve 120 can shut the flow of water through both the first and second chambers 134, 136 by blocking both the first and second openings 124a, 124b of the flow distributor 124.

In other configurations, the flow distributor 124 may be manipulated to rotate relative to the valve 120 and/or tilting panel 112 to cause the different spray patterns. In some configurations, the valve 120 and/or flow distributor 124 may be manipulated to rotate relative to a stationary tilting panel 112 to cause the different spray patterns.

In some cases, the tilting waterfall system 110 and its components, including, for example, the tilting panel 112, the valve 120, and/or the plate 140, can include a plastic material such as PVC (Polyvinyl Chloride) and/or ABS (Acrylonitrile Butadiene Styrene). The tilting waterfall system 110 and its components can be formed using injection molding. In some cases, the components of the tilting waterfall system 110 can be attached to each other using glue and/or ultrasonic welding. In some cases, the flow distributor 124 can be at least partially made of rubber, such as EPDM (ethylene propylene diene monomer) rubber. The rubber of the flow distributor 124 can beneficially prevent water leaks. The rubber can be formed using conventional molding techniques.

### Terminology

Although certain embodiments and examples are disclosed herein, inventive subject matter extends beyond the examples in the specifically disclosed embodiments to other alternative embodiments and/or uses, and to modifications and equivalents thereof. While we have described and illustrated in detail embodiments of a waterfall, it should be understood that our inventions can be modified in both arrangement and detail. For example, the features described herein can be incorporated into any type of spa or hot tub. Thus, the scope of the claims appended hereto is not limited by any of the particular embodiments described above. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

What is claimed is:

1. A tilting waterfall system comprising:
a tilting body configured to be in fluid connection with a source of water, the tilting body rotatable along an axis between a first position and a second position;
a first outlet positioned on the tilting body, the first outlet configured to output water in a first pattern;
a second outlet positioned on the tilting body, the second outlet configured to output water in a second pattern different from the first pattern;
a valve comprising a first opening and a second opening; and
a flow distributor comprising a first opening and a second opening;
wherein in the first position, the first opening of the valve and the first opening of the flow distributor are aligned thereby allowing flow of the water through the first outlet; and
wherein in the second position, the second opening of the valve and the second opening of the flow distributor are aligned thereby allowing flow of the water through the second outlet.

2. The tilting waterfall system of claim 1, wherein the first outlet comprises a slit.

3. The tilting waterfall system of claim 1, wherein the second outlet comprises a plurality of holes.

4. The tilting waterfall system of claim 1, wherein in the first position, the tilting body is configured to be arranged at an angle between 0° and 45° relative to a top surface of a spa unit.

5. The tilting waterfall system of claim 4, wherein in the second position, the tilting body is configured to be arranged at an angle between 45° and 90° relative to a top surface of a spa unit.

6. The tilting waterfall system of claim 1, wherein the tilting body is rotatable to a third position in which the first opening and the second opening of the valve are not aligned with either of the first opening and the second opening of the flow distributor thereby restricting the flow of water through the first outlet and the second outlet.

7. The tilting waterfall system of claim 1, wherein the tilting body comprises:
a first chamber in fluid communication with the first opening of the valve and the first outlet;
a second chamber in fluid communication with the second opening of the valve and the second outlet; and
a plate positioned between the first and second chambers and configured to seal the first and second chambers from each other.

8. The tilting waterfall system of claim 1, wherein the second outlet is arranged in a parallel to the first outlet.

9. The tilting waterfall system of claim 1, wherein the tilting body comprising a face having the first outlet and the second outlet.

10. The tilting waterfall system of claim 9, wherein the valve is positioned within the tilting body.

11. The tilting waterfall system of claim 10, wherein the valve is positioned on an opposite side of the tilting body from the first outlet and the second outlet, the flow distributor positioned between the valve and the first and second outlets.

12. A waterfall system for a spa unit, the waterfall system comprising:
a housing comprising a first outlet and a second outlet, the housing adjustable between at least a first position and a second position;
a flow restrictor positioned inside the housing;
wherein the flow restrictor blocks a first flow path toward the first outlet when the housing is in the second position; and
wherein the flow restrictor blocks a second flow path toward the second outlet when the housing is in the first position.

13. The waterfall system of claim 12, further comprising a flow distributor comprising a first opening and a second opening, wherein the flow restrictor comprises a first opening and a second opening, wherein the first opening of the flow restrictor and the first opening of the flow distributor are at least partially aligned when the housing is in the first position, and wherein the second opening of the flow restrictor and the second opening of the flow distributor are at least partially aligned when the housing is in the second position.

14. The waterfall system of claim 12, wherein the housing is in fluid communication with a source of water, wherein the first outlet is configured to spray water in a first pattern, and wherein the second outlet is configured to spray water in a second pattern different than the first pattern.

15. The waterfall system of claim 12, wherein the flow restrictor comprises a slit and the housing comprises a plate between the first flow path and the second flow path, the slit configured to receive and secure the plate.

16. The waterfall system of claim 12, wherein in the first position, the housing is configured to be arranged at an angle between 0° and 45° relative to a top surface of the spa unit.

17. The waterfall system of claim 12, wherein in the second position, the housing is configured to be arranged at an angle between 45° and 90° relative to a top surface of the spa unit.

18. The waterfall system of claim 12, further comprising a flow distributor comprising at least one stopper, wherein the flow restrictor comprises at least one tab, wherein the at least one stopper is configured to restrict movement of the stopper so that the housing is not movable beyond a position where the housing is arranged at a first angle relative to a top surface of the spa unit.

19. The waterfall system of claim 18, wherein the first angle comprises 0°.

20. The waterfall system of claim 18, wherein the first angle comprises 90°.

21. The waterfall system of claim 12, wherein the first outlet comprises a slit.

22. The waterfall system of claim 12, wherein the second outlet comprises a plurality of holes.

23. The waterfall system of claim 12, wherein the housing is adjustable to a third position wherein the flow restrictor blocks the first flow path and the second flow path.

24. The waterfall system of claim 12, wherein the first outlet is arranged in a parallel to the second outlet.
